(19) United States
(12) Patent Application Publication
(10) Pub. No.: US 2006/0060425 A1
(43) Pub. Date: Mar. 23, 2006

(54) Air/oil mist lubrication system and method of use

(76) Inventors: Curtis Richardson, Cedar Park, TX (US); Robert S. Hudson, Austin, TX (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 10/943,290

(22) Filed: Sep. 17, 2004

(51) Int. Cl. F16N 7/34

(52) U.S. Cl. 184/55.1

(57) ABSTRACT

Lubrication systems and methods for selectively lubricating bearings in a backup energy system (e.g., a compressed air storage system or a thermal and compressed air storage system) with an air/oil mixture are provided. The lubrication system may provide different levels of lubrication based on the operational status (e.g., standby mode or emergency power generation mode) of the backup system. For example, during periods of inactivity (e.g., standby mode), the lubrication system may intermittently apply the air/oil mixture to the bearings to compensate for oil burn-off and to ensure efficient transfer of power during backup power system startup. When the backup system is activated, the lubrication system may continuously apply the air/oil mixture to the bearings at a rate determined by the loading on the backup system.

### BACKGROUND OF THE INVENTION

This invention relates to the lubrication of bearings in a mechanical system. More particularly, this invention relates to the precision lubrication of components in a mechanical system that is alternatively subject to periods of inactivity and periods of activity such as, for example, bearings in a compressed air storage (CAS) system or in a thermal and compressed air storage (TACAS) system. The example of a TACAS system will be used to illustrate the principles of the invention. However, it will be noted that the invention may be applied to any mechanical component that may require lubrication.

In a TACAS system, compressed air is used to drive a turbine which in turn powers a motor through a shaft which connects the turbine and the motor. The shaft lies on bearings configured to efficiently transfer power from the turbine to the motor. Because the purpose of a TACAS system is to provide backup power to a load during a failure of a primary power source, the system may remain inactive for long periods of time (e.g., months). To ensure that the TACAS system can be started up and provide power in response to a load in a timely fashion, it is important to make sure that the bearings holding the shaft are optimally lubricated.

In conventional systems, grease packs are generally used to provide lubrication for the bearings. However, grease packs have significant limitations, including a limited lifespan. Grease packs also exhibit insufficient lubrication life when compared to the average 20 year lifespan of a TACAS system. In addition, grease packs are subject to burn off during turbine operation, especially during turbine spool-up. Also, grease packs allow dirt, water and other debris to come into contact with the bearings, resulting in increased wear and tear and may cause oxidation, thereby limiting the lifespan of the bearings.

In other conventional systems, oil-mist lubrication systems are relied upon to provide lubrication to bearings. However, oil-mist systems may require a continuous flow of oil, which may result in wasted use of oil, especially when the system, such as a TACAS system, is not in operation, and the wasted oil-mist affects the operation of surrounding systems. In addition, not all oils can be converted to mist, so specific blends may be required. Finally, having too much oil in the bearings can adversely affect the efficiency of the TACAS system by creating additional friction between the oil and the shaft.

In still other conventional systems, air/oil lubrication is used. In such systems, vaporized oil is carried by air from an air supply and is provided in a constant flow to the bearings. However, such systems can cause too much oil to deposit on the bearings, which can adversely affect power transfer in a turbine system that drives an electrical generator via a shaft. Another drawback of air/oil lubrication system is that a constant air/oil supply may be provided to the bearings regardless of whether the turbine is operating, resulting in wasted oil.

Accordingly, it would be desirable to provide a lubrication system for efficiently lubricating bearings, brushings, or other mechanical component such that multiple levels of lubrication are available, depending on the lubrication need of the system at a given time.

### SUMMARY OF THE INVENTION

This and other objects of the present invention are accomplished in accordance with the principles of the present invention by providing control circuitry combined with an air/oil mist lubrication system. The control circuitry controls the air/oil mist lubrication system such that an appropriate amount of lubrication is supplied to a bearing or other mechanical component (e.g., bushing) on an as needed basis. For example, the lubrication system may be used to lubricate one or more bearings in a stored gas electrical generation system such as a TACAS system.

In one embodiment, the control circuitry may instruct the lubrication system to provide a predetermined quantity of oil in the form of an air/oil mist to the bearings at predetermined intervals when the TACAS system is not in operation (e.g., standby mode). This ensures that the bearings are sufficiently lubricated to facilitate, for example, spool-up of a turbine-generator when the TACAS system switches from standby mode to an active mode of operation (e.g., power generation mode). In an active mode, the control circuitry may instruct the lubrication system to continuously provide oil (in the form of an air/oil mist) to the bearings.

In another embodiment, the control circuitry may determine the lubrication needs of the bearings and instruct the lubrication system to lubricate the bearings in response to these needs. For example, the control circuitry may instruct the lubrication system to increase the lubrication rate during high load conditions and to decrease the lubrication rate during low load conditions. As another example, lubrication system may lubricate the bearings at irregular intervals, using different lubrication rates, as necessary to maintain optimal lubrication. In still another embodiment, the control circuitry may instruct the lubrication system to provide varying quantities of oil to the bearings in non-constant flow rates.

### BRIEF DESCRIPTION OF THE DRAWINGS

The above and other features of the present invention, its nature and various advantages will become more apparent upon consideration of the following detailed description, taken in conjunction with the accompanying drawings, in which like reference characters refer to like parts throughout, and in which:

FIG. 1 is a schematic diagram of a system in which a lubrication system is used in accordance with the principles of the present invention;

FIG. 2 is a block diagram of a lubrication system in accordance with the principles of the present invention;

FIG. 3 is a schematic diagram of the system of FIG. 2 in accordance with the principles of the present invention;

FIG. 4 is a schematic diagram of a portion of the system of FIG. 3 in accordance with the principles of the present invention;

FIG. 5 is a timing diagram showing a standby mode operation of a lubrication system in accordance with the principles of the present invention;

FIG. 6 is a timing diagram showing an emergency mode of operation of a lubrication system in accordance with the principles of the present invention;

FIG. 7 is a schematic diagram of the system of FIG. 2 being used in the context of a TACAS system in accordance with the principles of the present invention; and

FIG. 8 is a flow chart of a method of use of the system of FIG. 2 in accordance with the principles of the present invention.

FIG. 9 is a schematic diagram of the system of FIG. 2 being used in the context of a continuously operating power generation system in accordance with the principles of the present invention.

### DETAILED DESCRIPTION OF THE INVENTION

The present invention has a number of different applications, each of which may warrant modification of parameters such as oil flow rates, tubing, and orifice sizes. Therefore, it is believed best to describe certain aspects of the invention with reference to simplified schematic drawings. To keep the discussion from becoming too abstract, however, and as an aid to better comprehension and appreciation of the invention, references will frequently be made to specific uses of the invention. Many of these references may be the use of the invention to provide precision lubrication to bearings supporting a shaft in a TACAS system, where lubrication may depend on the operating status of the TACAS system. It is emphasized again that this is only one of many possible applications of the invention.

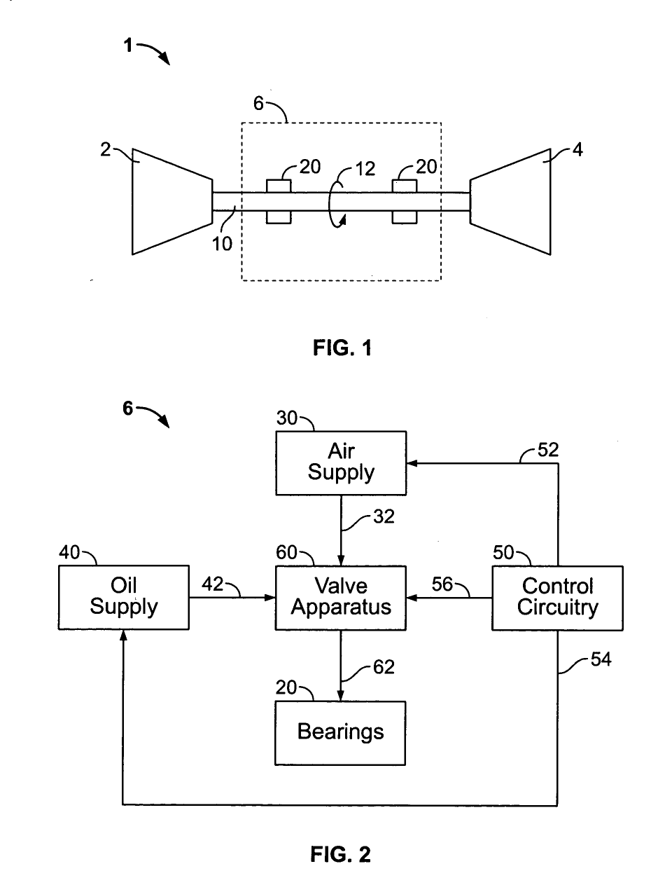

FIG. 1 shows mechanical system 1 which includes turbine 2 and electrical machine 4. Turbine 2 may be connected to electrical machine 4 by shaft 10, which may be configured to transfer power from the turbine to the motor, or vice versa. Shaft 10 is supported by bearings 20, which allow shaft 10 to rotate in direction 12 or in the direction opposite direction 12 with minimal losses due to friction. In one embodiment, turbine 2, shaft 10 and electrical machine 4 may be arranged in a horizontal configuration. In another embodiment, turbine 2, shaft 10 and electrical machine 4 may be arranged in a vertical configuration. In yet another embodiment, turbine 2, shaft 10 and electrical machine 4 may be arranged in a configuration between a horizontal configuration and a vertical configuration. Though FIG. 1 shows that turbine 2 is connected to electrical machine 4 via shaft 10, it will be understood that such an arrangement is merely an illustration. For example, electrical machine 4 and turbine 2 may be coupled to each other, with bearings 20 contained therein to support shaft 10. Such an arrangement is commonly referred to as a turbine-generator.

Turbine 2 may, for example, be a gas turbine, a microturbine, a fuel cell/gas turbine hybrid system, a fluid-drum turbine, or any other suitable turbine capable of driving a shaft. Electrical machine 4 may, for example, be an electric motor, an electric generator, a synchronous machine, an electrical machine that may function as both a generator and a motor, or any other suitable machine that uses or produces electrical power.

Lubrication system 6 is configured to provide lubrication to the bearings to minimize friction between shaft 10 and bearings 20. In particular, lubrication system 6 may be configured to selectively lubricate the bearings as required by the status of mechanical system 1. For example, if turbine 2 is not in operation (e.g., in standby mode), there may be minimal need for lubrication of bearings 20. In contrast, if turbine 2 is in operation (e.g., an emergency or active mode), shaft 10 rotates and bearings 20 may require continuous lubrication to ensure efficient transfer of power to motor 4.

FIG. 2 is a more detailed schematic diagram of lubrication system 6. Lubrication system 6 includes air supply 30, oil supply 40, control circuitry 50 and valve apparatus 60. Air supply 30 may provide compressed air from any suitable source such as, for example, a compressed air pressure tank in a TACAS system, shop air, or an air reservoir (e.g., cavern). Such air may be supplied to valve apparatus 60 via 32 tubing. Persons skilled in the art will readily recognize that fluids other than air may be employed by lubrication system 6. For example, an inert gas may be supplied by the air supply 30. However, for the ease of illustration of the discussion, air will be used for the description of the invention.

Oil supply 40 may include any suitable oil or other natural or synthetic product that can lubricate bearings 20. As defined herein, “oil” is a substance that provides the physical effects desired in a lubricant. The oil provided by oil supply 40 is preferably in a liquid phase, but may also be in a gaseous phase, or in any other suitable phase. Oil supply 40 may supply oil to valve apparatus 60 via tubing 42.

Valve apparatus 60 may produce an air/oil mixture using air received from air supply 30 and oil received from oil supply 40 and selectively supply the air/oil mixture to bearings 20 via tubing 62. To produce the air/oil mixture, value apparatus 60 may route air received from air supply 30 to bearings 20, thereby developing a pressure system (e.g., a low pressure system) within valve apparatus 60. This pressure system may siphon oil from oil supply 40 into valve apparatus 60. As the oil enters the valve apparatus, it mixes with the air and atomizes. The oil droplet size may range from about 1.0 to about 3.0 microns, though the size may depend on a variety of variables, including the air flow rate (in which air is routed from air supply 30 to bearings 20) and the oil properties, including viscosity and surface tension. Therefore, persons skilled in the art will appreciate that the oil droplets may vary in sizes other than between 1.0 to 3.0 microns. In some cases, the droplet sizes may be less than 1.0 microns, while in other cases, the droplet sizes may be more than 3.0 microns.

The air/oil mixture created in valve apparatus 60 may be directed to bearings 20 through tubing 62 with the air supplied from air supply 30. The air/oil mixture may then be fed into bearings 20 as a fine spray or mist of oil. The air/oil mixture may condense on bearings 20 and form a microscopic coat of oil for lubrication. The oil particles from the air/oil mixture may pass through an orifice, reclassifier or mist fitting, (not shown) which may cause some particles to collide and combine before reaching the bearings. The larger, combined particles may be better adapted to wet the bearings, and thus enhance the efficiency of the system to deposit a thin oil film on the bearings. A further advantage of the invention is that all or substantially all of the oil may be deposited directly onto bearings 20. The proximity of the microscopic particles to the bearings as they flow allows most particles to condense against the bearings. As a result, the quantity of oil required for proper lubrication is relatively small compared to prior art lubrication systems.

Control circuitry 50 may be connected to air supply 30, oil supply 40 and valve apparatus 60 communications path by 52, 54 and 56, respectively. Control circuitry 50 may include electrical, mechanical, or a combination of electrical and mechanical means for controlling the different components (e.g., valve 60) of lubrication system 6. For example, control circuitry 50 may be configured to control the air flow rate of air flowing from air supply 30 through tubing 32. Such control may be exercised by adjusting, for example, a pressure regulator or a flow control valve. Control circuitry 50 may control the quantity of oil flowing out of oil supply 40 into tubing 42. Control circuitry 50 may control valve apparatus 60 to control the quantity of the air/oil mixture supplied to bearings 20.

Control circuitry 50 may include a user interface that enables a user to specify the control of the lubrication of bearings 20. For example, a user may provide a program that causes the control circuitry 50 to lubricate bearings 20 according to a desired lubrication scheme. Control circuitry 50 may receive data that indicates the lubrication status of the system and may automatically adjust lubrication based on that data.

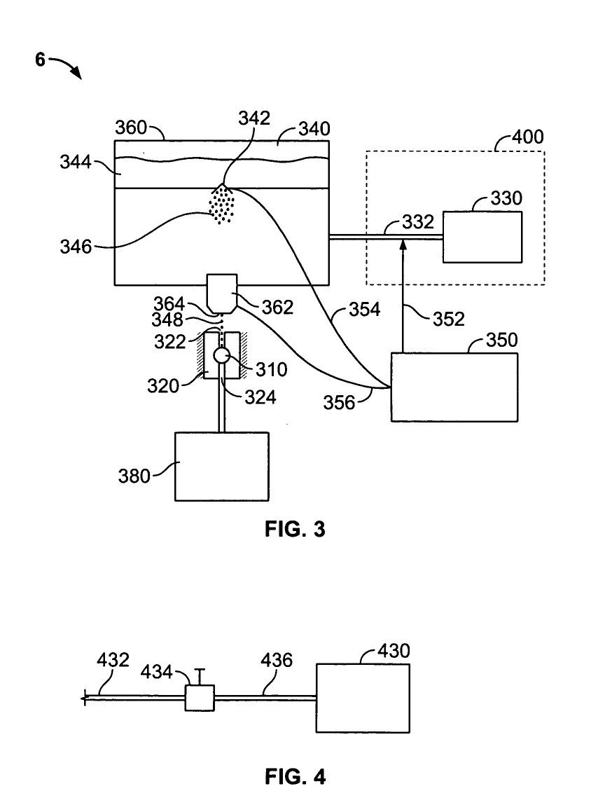

FIG. 3 shows a more detailed view of the lubrication system schematically shown in FIG. 2. Oil supply 340 is incorporated into valve apparatus 360. Valve 342, coupled between oil supply 360 and the main chamber of valve apparatus 360, may be configured to allow oil into the main chamber (shown as the portion of valve 360 under oil supply) of the valve apparatus. Control circuitry 350 may be connected to valve 342 by communications path 354, enabling the control circuitry to control the quantity of liquid oil 344 that may flow into the main chamber of valve apparatus 360 (e.g., a plenum) by controlling the operation of valve 342.

Air source 400 may include air supply 330 and tubing 332. Air supply 330 provides compressed air to valve apparatus 360 via tubing 332, which is connected to control circuitry 350 by communications path 352. In one embodiment, control circuitry 350 controls the air flow through tubing 332 by controlling a valve (not shown). When control circuitry 350 permits air and oil to flow from air supply 330 and oil supply 340 into valve apparatus 360, respectively, liquid oil 344 vaporizes into an air/oil mixture 346 in the valve apparatus upon contact with the air.

As stated above in connection with the text accompanying FIG. 2, a pressure system is developed as air is drawn from air supply and routed to the bearings. As such the quantity of oil siphoned from oil supply 340 may be a function of the rate in which air is routed drawn from air supply 400. Control circuitry 350 may further enhance control the quantity of oil provided to the main chamber of valve apparatus 360 by adjusting valve 342 and/or the air flow of air into valve apparatus. For example, control circuitry 350 may maintain valve 392 in a fixed position and vary the air flow rate, as desired, to increase or decrease the quantity of oil supplied to the main chamber. As another example, control circuitry 380 may maintain a relatively constant air flow and adjust valve 342 as desired to increase or decrease the quantity of oil supplied to the main chamber.

Valve apparatus 360 may include valve 362, which may be controlled by control circuitry 350 through communications path 356. When valve 362 is opened, oil mist 346 from inside valve apparatus 360 flows out of valve 362, pushed by air from air supply 330. The air flows through inlet 322, around shaft 310, and out outlet 324, carrying oil particles 348 from the air/oil mixture. As oil particles 348 reach bearings 320, the particle may condense between bearings 320 and shaft 310 and provide precision lubrication. While the oil is deposited on bearings 320, the air, which carried the oil, may flow past the bearings and out of outlet 324. In an embodiment, as shown in FIG. 3, valve 362 may be positioned so that air/oil mixture 346 flowing through valve 362 enters inlet 322 (by the pull of gravity) to lubricate the bearings.

In one embodiment, bearings 320 may be contained within a pressurized vessel or bearing housing (not shown). The pressurized vessel prevents, for example, dirt, water, and other debris from coming into contact with the bearings, thereby reducing the potential for shortening the life span of the bearings (due to wear and tear oxidation or other deleterious effects). In such an embodiment, valve 362 may be coupled to the pressurized vessel or bearing housing via a fluid routing means (e.g., pipe or tubing) to permit a pressurized flow of the air/oil mixture to the bearings. As the air/oil mixture flows from valve 362 to bearings 322, a portion of the oil from the air/oil mixture may condense and accumulate as a film along the inside wall of the fluid routing means. Despite such oil accumulation, the air flowing through the fluid routing means pushes the oil film along the inside wall to the bearings. Thus, it will be appreciated that both an air/oil mixture and a thin film of oil may be supplied to bearings 320 for lubrication.

Lubrication system 6 may also include sump pump 380 to recover excess oil that passes through outlet 324. Sump pump 380 may also be configured to recover any oil that burns off of bearings 320. The oil that is recovered by sump pump 380 may then be recycled and re-used, or disposed of in accordance with applicable regulations. Thus, an advantage of lubrication system 6 is that it is more environmentally friendly than previous systems because a recycling function may easily be incorporated in the design of the lubrication system.

FIG. 4 shows an embodiment of air source 400 that is in accordance with the principles of the invention. Air supply 430 may provide air at a high pressure. In a TACAS system, for example, air supply 430 may be provided in one or more high pressure storage vessels that store gas at relatively high pressures (e.g., pressures larger than 1000). To provide pressures manageable for a valve apparatus such as valve apparatus 360 (FIG. 3), and to permit use of small, flexible, and/or low pressure fluid routing means, air source 400 may further include regulator 434. Regulator 434 may reduce the pressure of the gas in high pressure tubing 436 to a predetermined pressure for low pressure tubing 432. For example, regulator 434 may reduce the air pressure from over 1000 psi to 400 psi. In another example, regulator 434 may reduce the air pressure to less than 1 psi. If desired, control circuitry 350 (FIG. 3) may regulate air provided by air supply 430 by controlling regulator 434.

In an embodiment in which the system control air is used (e.g., shop air), the system control air pressure may be 125 psi, which may be too high for air/oil mist lubrication. A step-down in pressure to 50-75 psi may be required to provide an appropriate pressure for delivery of the air to the valve apparatus. This step-down may require an additional intermediate regulator or similar device (not shown) to perform the step-down function.

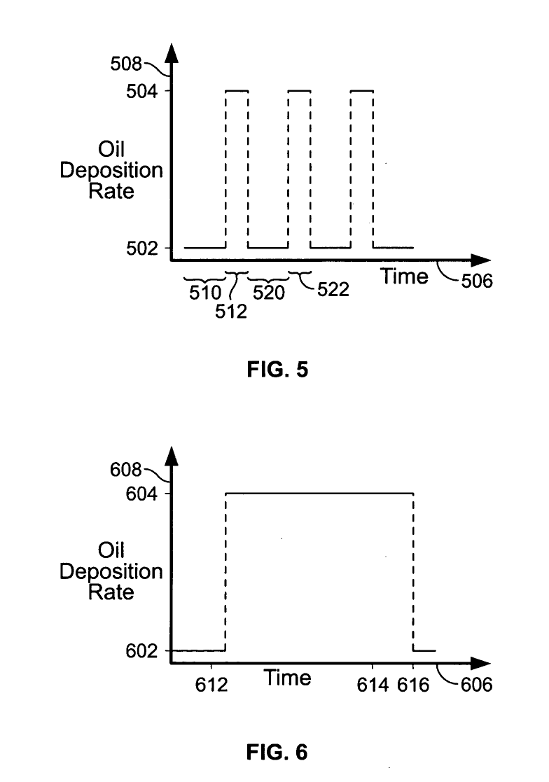

FIGS. 5 and 6 show timing diagrams of lubrication provided by system 6 (FIG. 3) in two modes of operation of system 1 (FIG. 1) in accordance with the principles of the invention.

FIG. 5 shows a timing diagram of oil deposition rate 508 versus time 506 when system 1 is in an inactive mode of operation. During a standby mode of operation, lubrication system 6 may intermittently apply the air/oil mixture to the bearings to keep the bearings primed for a transition to an active or emergency mode of operation. System 1 may not require continuous lubrication during standby mode because there is minimal or no motion between bearings 320 and shaft 310 (FIG. 3). The intermittent supply of oil may be needed to replace oil that has burned off. For example, the bearings of system 1 may be kept in a room or storage compartment that has a relatively high temperature, which may cause the oil to burn off.

As shown in FIG. 5, the quantity of oil applied to the bearings ranges between oil deposition rates 502 and 504 at different time intervals. Oil deposition rate 502 represents a minimal, negligible, or non-existent application of oil to the bearings. Oil deposition rate 504 represents a predetermined or fixed application of oil to the bearings. The quantity of oil deposited at rate 504 may depend on a number of factors, including by not limited to, the size of the bearings, the resting time (discussed below), and the oil burn-off rate.

During standby mode, there may be periods of time (e.g., resting times) such as time periods 510 and 520 in which lubrication system 6 operates at oil deposition rate 502. The time duration of the resting times may be a function of the burn-off rate, the quantity of oil deposited during lubrication times (discussed below), and other factors. In addition, there may be periods of time (e.g., lubrication times) such as time periods 512 and 522 in which lubrication system 6 operates at oil deposition rate 504.

As an example implementation of the foregoing, control circuitry 350 may instruct lubrication system 6 to deposit 0.006 cubic inches of oil for 10 seconds every hour. In another example, lubrication system 6 may apply the air/oil mixture to the bearings for 5 to 10 seconds every 12 hours. Persons skilled in the art will appreciate that these values are merely examples, and any combination of oil deposition rates, lubrication times, and resting times may be used.

The ramp up and ramp down time required to change between oil deposition rates may vary. For example, the change between deposition rates may be instantaneous, progressive, linear, or any suitable combination thereof.

It is understood that the oil deposition rates, resting times and lubrication times need not be fixed, but that such rates and times may be variable. For example, control circuitry 350 may instruct lubrication system 6 to deposit oil at multiple oil deposition rates for different lubrication and resting times. For example, control circuitry 350 may instruct lubrication system 6 to deposit oil at a first rate for a first lubrication time, rest for a first resting time, deposit oil at a second deposit rate (which may be less than the first deposit rate) for a second lubrication time, and rest for a second resting time (which may be longer than the first resting time).

Control circuitry 350 may be operative to receive status data from bearings 320 regarding the quantity of oil in the bearings. One or more sensors or detectors may be provided on or around the bearings to acquire status data regarding, for example, the quantity and quality of the oil in the bearings. The sensors or detectors may be connected to the control circuitry to transmit the acquired status data for processing. Control circuitry 350 may receive the status data at regular intervals such as, for example, every minute, every 5 minutes, every hour, every 12 hours, every day, or any other suitable interval. Upon receipt of the status data, control circuitry 350 may determine whether any additional oil should be deposited on the bearings. If control circuitry 350 determines that bearings 320 need additional oil, the control circuitry may determine a suitable oil deposit rate and lubrication time to lubricate the bearings. Alternatively, the control circuitry may automatically provide a series of oil deposit rates, lubrication times, and resting times to lubricate the bearings based on the status data.

FIG. 6 shows a timing diagram of oil deposition rate 608 versus time 606 when system 1 is in an active mode of operation. When system 1 is activated at time 612 on FIG. 6, shaft 310 starts rotating in bearings 320, and power is supplied to the load. To protect the bearings and to promote efficient power transfer from turbine 2 to electrical machine 4 (FIG. 1), lubrication system 6 may provide a continuous supply of oil to the bearings.

At time 612, or shortly thereafter, lubrication system 6 may lubricate bearings at deposition rate 604. Lubrication system 6 may continue to lubricate bearings until the load is removed from the system and shaft 310 is no longer required to transfer power, indicated in FIG. 6 as time 614. Alternatively, lubrication system 6 may continue to apply oil to the bearings for a pre-determined period of time after shut down to ensure that the bearings are sufficiently lubricated during rotor spool-down, as indicated as time 616.

During system shut down, control circuitry 350 may instruct lubrication system 6 to instantaneously change the oil deposit rate from rate 604 to rate 602 at time 616. In an alternate embodiment, lubrication system 6 may progressively decrease the oil deposit rate from rate 604 to rate 602. System 1 then returns to an inactive state during which a lubrication scheme such as that shown in FIG. 5 is applied.

It is understood that the oil deposition rate need not be set at a constant level when system 1 is in an action mode of operation. For example, the oil deposition rate may vary with the load being applied to system 1. In particular, as the load increases or decreases, the oil deposit rate may increase or decrease accordingly to provide efficient lubrication for system 1. Control circuitry 350 may monitor the bearings during periods of power generation and adjust the quantity of oil being applied, as needed.

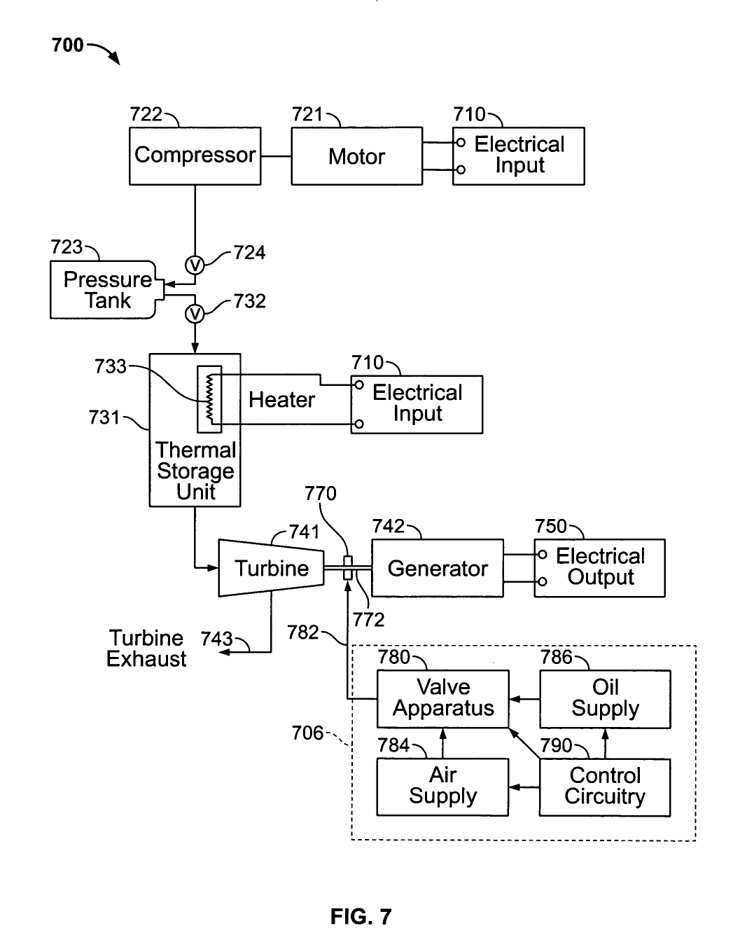

FIG. 7 shows the lubrication system of FIG. 2 being used in the context of a TACAS system such as, for example, the TACAS systems of commonly owned U.S. patent application Ser. No. 10/361,728 (hereinafter “the '728 application”), filed Feb. 5, 2003, and U.S. patent application Ser. No. 10/361,729 (hereinafter “the '729 application”), filed Feb. 5, 2003, both of which are incorporated by reference in their entireties herein. It is understood that the following discussion with reference to FIG. 7 is not intended to be a comprehensive discussion of TACAS system, but a simplified discussion of such a system in which the lubrication system of the present invention may be incorporated. It is further understood that the lubrication system of the present invention is not limited to being incorporated in the system shown in FIG. 7 but may be used in other systems such as compressed air storage systems, HVAC systems, in addition to other systems disclosed in the '728 and '729 applications.

TACAS system 700 may include an electrical input 710 that provides input power to motor 721, which may be any conventional type of motor (e.g., a rotary electric machine). Electrical input 710 may be utility power or, for example, a battery or other short term power supply. Motor 721 is coupled to compressor 722 so that when motor 721 is receiving power from electrical input 710, it drives compressor 722. Compressor 722 supplies compressed air through a valve 724 into pressure tank 723. Compressor 722 may be any type of compressor which compacts or compresses air (e.g., atmospheric air) to occupy a smaller space inside of pressure tank 723.

When electric power is needed from TACAS system 700, compressed air from pressure tank 723 is routed through valve 732 to thermal storage unit (TSU) 731. TSU 731, as shown in FIG. 7, heats the gas from pressure tank 723 using an exhaustless heater, or non-combustion heater. In FIG. 7, heater 733 is a resistive heater powered by electrical input 710.

The hot air emerging from TSU 731 flows against the turbine rotor (not shown) of turbine 741 and drives turbine 741, which may be any suitable type of turbine system (e.g., a radial-flow turbine). In turn, turbine 741 drives electrical generator 742 via shaft 772, and electrical generator 742 produces power that is provided to electrical output 750.

Also shown in FIG. 7 is turbine exhaust 743 (e.g., the exhaust gases emerging from turbine 741). Turbine exhaust 743 may be vented through an exhaust pipe (not shown), or simply released to recombine with atmospheric air.

Lubrication system 706 may lubricate bearings 770 (only one bearing is shown) in accordance with the principles of the present invention. As discussed above, such lubrication may be performed on an as needed basis. For example, lubrication system 706 may lubricate bearings 770 intermittently when TACAS system 700 is operating in a standby mode (i.e., TACAS is not generating power). Lubrication system 706 may continuously lubricate bearings 770 when TACAS system 700 is operating in an emergency mode (i.e., TACAS system 700 is generating power).

Lubrication system 706 may be similar to lubrication system 6 (as described above in connection with FIGS. 2-4) and thus may operate in a similar manner. In addition, lubrication system 706 may be constructed using many of the same components used in lubrication system 6 of FIG. 2. For example, lubrication system 706 may include valve apparatus 780, air supply 784, oil supply 786, and control circuitry 790.

Valve apparatus 780 may provide atomized oil to bearings 770 via tubing 782. As discussed above, atomization of the oil may occur within valve apparatus 780 when air, which is supplied from air supply 784, is mixed with oil, which is supplied from oil supply 786. Air supplied by air supply 784 may be derived from compressor 722 through additional tubing, valves, regulators, and/or flow control valves (not shown), or from pressure tank 723 through additional tubing valves, pressure regulators, and/or flow control valves (not shown). Control circuitry 790 may control the supply of air and oil provided to valve apparatus 780 to provide optimal lubrication to bearings 770.

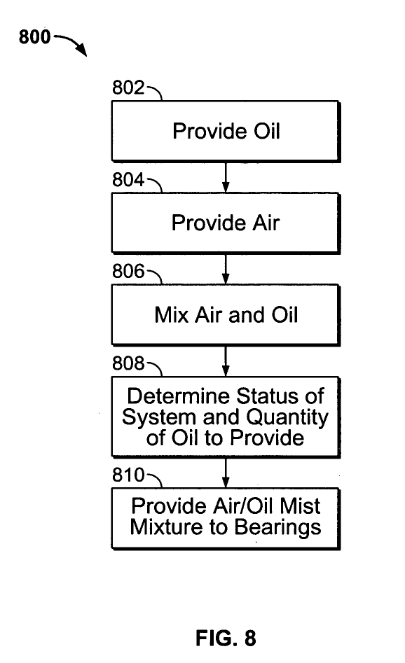

FIG. 8 shows a flow chart 800 of a method of use of a lubrication system in accordance with the principles of the present invention. In step 802, oil is provided. In step 804, compressed air is provided. The compressed air may be provided from a compressed air storage tank provided with the lubrication system, a compressed air storage tank provided with another system (e.g., TACAS system), shop air, or any other suitable source of compressed air.

In step 806, the oil and air provided in steps 802 and 804, respectively, are mixed. The oil may be drawn into the air flow because of a pressure system developed by the movement of air. The mixture of air and oil may cause the oil to atomize and create an oil mist or air/oil mixture. In step 808, the status of the system being lubricated is determined. For example, the lubrication system may determine whether the system to be lubricated is active, inactive or in transition. In one embodiment, control circuitry may perform this determination step. At step 810, the air/oil mixture is provided to the bearings for lubrication. The air/oil mixture may be provided intermittently (e.g., at predetermined intervals) or continuously, depending on the status of the system.

An advantage of the lubrication system according the present invention is that it may be implemented many different types of systems. FIG. 7, for example, illustrated a possible implementation of the lubrication system in a TACAS backup energy system. If desired, the lubrication system according to the present invention may be used in other energy systems such as continuously operating electrical generation systems. Such systems are different from backup energy systems in that they may generate power on a continuous basis.

During operation of a continuously operating electrical generation system, the lubrication demands of the system may vary. For example, during periods of high load demand, increased levels of lubrication may be needed. However, during periods of reduced demand, such increased levels of lubrication may not be needed, and lubrication level may be decreased. The lubrication system according to the present invention may selectively lubricate, on an as needed basis, thereby optimally lubricating bearings or other components of a continuously operating electrical generation system.

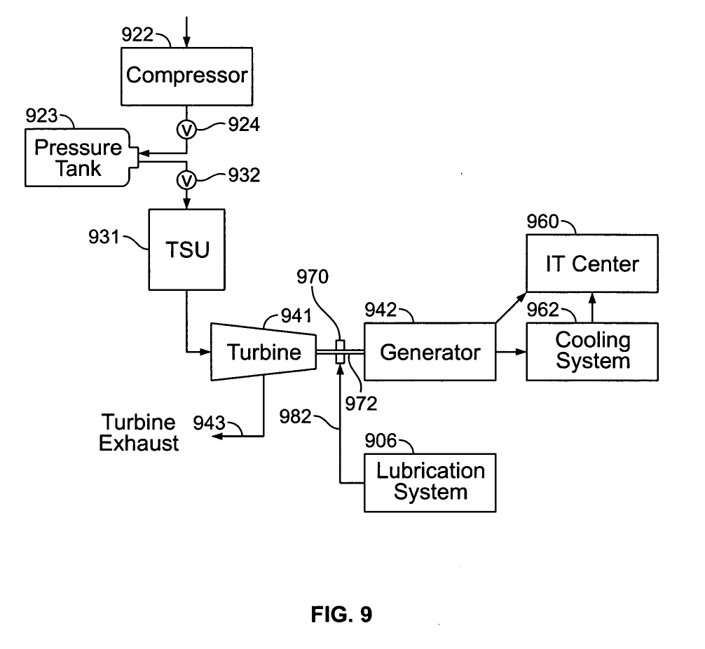

FIG. 9 shows an exemplary continuously operating power generation system 900 that uses a lubrication system according to the principles of the present invention. Power generation system 900 may be a continuously operating TACAS power generation system. Such a system may share many of the features and operating principles of TACAS power generation system 700 of FIG. 7, except that it may operate continuously, as opposed to operating for predetermined period of time to provide backup power. System 900 may operate continuously to supply power to IT center 960 (e.g., a computer center) and cooling system 962, which may provide appropriate environmental conditions for IT center 960.

Power generation system 900 may include compressor 922, valve 924, pressure tank 923, valve 932, TSU 931, turbine 941, generator 942, IT center 960, cooling system 962, and lubrication system 906. Lubrication system 906 may be a system similar to that described above in connection with FIGS. 2-4. Compressor 922 may operate continuously to provide compressed air, which may eventually be used to drive turbine 941. Compressor 922 may compress ambient air that is routed through valve 924 for storage in pressure tank 923. Compressor 922 may have the capacity to charge pressure tank 923 at a rate faster than the rate at which air is drawn from pressure tank 923. This may ensure that sufficient air contained pressure is maintained in pressure tank 923 to enable system 900 to generate electrical power because compressed air may be drawn from pressure tanks 923 to power turbine 941.

In an alternative arrangement, compressor 922 may be operable to provide compressed air directly to TSU 931. In such an arrangement, pressure tank 923 and valve 923 may be removed and compressor 922 may be coupled directly to valve 932. Moreover, in such an arrangement, compressor 923 may provide sufficient pressure upstream of valve 932 to enable system 900 to generate electrical power.

Regardless of whether air is supplied directly by a compressor or by a pressure tank or other storage system, the air may be routed through TSU 931 prior to being provided to turbine 941. TSU 931 may heat the air to a desired temperature to improve the operating efficiency of turbine 931. It will be understood that many different types of TSUs or other heat exchanging systems may be used to raise the temperature of the air. If desired, air may be routed to turbine 941, bypassing TSU 931. Turbine 941 drives generator 942 through shaft 972 when air is supplied to the turbine inlet. Shaft 972 may be supported by bearings 970 (only one of which is shown). As turbine 941 drives generator 942, power is supplied to IT center 960 and cooling system 962.

To ensure optimal lubrication of bearings 970 and to provide efficient power transfer from turbine 941 to generator 942, lubrication system 906 may selectively lubricate bearings 970 in accordance with the principles of the present invention. Such lubrication may ensure that friction between bearings 970 and shaft 972 is kept to a minimum over a wide range of operating conditions, including load demands and burn-off. For example, lubrication system 906 may continuously supply an air/oil mixture to bearings 970, but may adjust the quantity of the supply based on the load demanded of generator 942.

Thus, systems and methods for optimizing lubrication of bearings or other mechanical components are provided. The above described embodiments of the present invention are presented for purposes of illustration and not of limitation, and the present invention is limited only by the claims which follow.

What is claimed is:

1. A method for lubricating at least one bearing that supports a shaft in a turbine-generator backup power supply, comprising:
providing compressed fluid;
providing oil;
mixing said compressed fluid and said oil to provide a fluid/oil mixture;
supplying said fluid/oil mixture to said at least one bearing in predetermined intervals while said backup power supply is operating in a standby mode of operation; and
continuously supplying said fluid/oil mixture to said at least one bearing while said backup power supply is operating in an emergency mode of operation.

2. The method defined in claim 1, wherein said compressed fluid is a compressed gas and said fluid/oil mixture is a gas/oil mixture.

3. The method defined in claim 2, wherein said gas is air and said gas/oil mixture is an air/oil mixture.

4. The method defined in claim 1, wherein said mixing comprises vaporizing said oil with said compressed fluid to provide said fluid/oil mixture.

5. The method defined in claim 1, wherein said fluid/oil mixture is an atomized mist of oil droplets.

6. The method defined in claim 1, wherein during said standby mode of operation, said supplying comprises providing a predetermined quantity of said fluid/oil mixture to said at least on bearing.

7. The method defined in claim 1, wherein during said standby mode of operation, said supplying comprises varying the quantity of said fluid/oil mixture being supplied to said at least one bearing.

8. The method defined in claim 1, wherein during said emergency mode of operation, said supplying comprises continuously providing a predetermined quantity of said fluid/oil mixture to said at least one bearing.

9. The method defined in claim 1, wherein during said emergency mode of operation, said supplying comprises varying the quantity of said fluid/oil mixture continuously being supplied to said at least one bearing.

10. The method defined in claim 1 in which said backup power supply is operating in said standby mode, further comprising:
monitoring the status of said at least one bearing;
adjusting said predetermined intervals in which said fluid/oil mixture is supplied to said at least one bearing based on said monitoring; and
varying the quantity of said fluid/oil mixture supplied to said at least one bearing based on said monitoring.

11. The method defined in claim 1 in which said backup power supply is operating in said emergency mode, further comprising:
monitoring the status of said at least one bearing; and
varying the quantity of said fluid/oil mixture being continuously supplied to said at least one bearing based on said monitoring.

12. The method defined in claim 1 further comprising:
continuously supplying said fluid/oil mixture for a predetermined period of time immediately after said backup power supply changes operation modes from said emergency mode to said standby mode.

13. The method defined in claim 1, wherein said turbine-generator backup power supply is a thermal and compressed air storage power supply.

14. The method defined in claim 1 further comprising:
recycling oil supplied to said at least one bearing.

15. A method for selectively lubricating a mechanical component of a compressed fluid storage power supply during periods of emergency power generation and during standby periods, said method comprising:
intermittently applying an atomized mist of oil to said mechanical component during said standby periods; and
continuously applying said atomized mist of oil to said mechanical component during said periods of emergency power generation.

16. The method defined in claim 15, wherein said atomized mist of oil comprises oil droplets ranging in size from about 1.0 microns to about 3.0 microns.

17. The method defined in claim 15, wherein said periods of emergency power generation comprise applying a substantial load to said mechanical component.

18. The method defined in claim 15, wherein said standby periods comprise applying a negligible load to said mechanical component.

19. A lubrication system for lubricating at least one bearing, comprising:
a source of compressed fluid;
a source of oil;
a fluid/oil mixture assembly coupled to said fluid source, said oil source, and said at least one bearing, said assembly operable to mix said compressed fluid and said oil to produce a fluid/oil mixture; and
control circuitry coupled to said assembly and operative to control said assembly to selectively apply said fluid/oil mixture to said at least one bearing.

20. The system defined in claim 19, wherein said assembly comprises:
a mixing chamber coupled to said fluid source and said oil source; and
a valve coupled to said mixing chamber and connected to said control circuitry, said valve operative under the command of said control circuitry to supply a predetermined quantity of said fluid/oil mixture to said at least one bearing.

21. The system defined in claim 19 further comprising a pressure regulator coupled to said source of compressed fluid.

22. The system defined in claim 21, wherein said control circuitry controls said pressure regulator.

23. The system defined in claim 19, wherein said control circuitry controls said assembly to apply a predetermined quantity of said fluid/oil mixture once every predetermined time interval when said at least one bearing is in a LOW load operating mode.

24. The system defined in claim 19, wherein said control circuitry controls said assembly to continuously apply a predetermined quantity of said fluid/oil mixture when said at least one bearing is in a HIGH load operating mode.

25. The system defined in claim 19 further comprising:
monitoring circuitry to monitor the status of said at least one bearing, said monitoring circuitry provides status information to said control circuitry.

26. The system defined in claim 19 further comprising:
a pressurized tubing configuration for routing said fluid/oil mixture to said at least one bearing.

27. The system defined in claim 19 wherein said compressed fluid is a compressed gas and said fluid/oil mixture is a gas/oil mixture.

28. The system defined in claim 27 wherein said compressed gas is compressed air and said gas/oil mixture is an air/oil mixture.

29. A lubrication system for use in a compressed air storage power supply that lubricates at least one mechanical component during a standby mode of operation and during an emergency mode of operation, said system comprises:
a turbine coupled to a shaft that drives a generator during said emergency mode of operation, said shaft being supported by said at least one mechanical device;
a source of compressed fluid;
a source of oil; and
a valve assembly coupled to said fluid source, said oil source, and said at least one mechanical component, said assembly operable to mix said compressed fluid and said oil to produce a fluid/oil mixture, said valve assembly further operative to intermittently apply said fluid/oil mixture to said at least one mechanical component during said standby mode of operation, and said valve assembly further operative to continuously apply said fluid/oil mixture to said at least one mechanical component during said emergency mode of operation.

30. The system defined in claim 29 further comprising:
control circuitry connected to said valve assembly and operative to control the operation of said valve assembly.

31. The system defined in claim 29, wherein the coupling between said valve assembly and said at least one mechanical component is a pressurized housing.

32. The system defined in claim 29, wherein said at least one mechanical component is a bearing or a bushing.

33. The system defined in claim 29, wherein said source of compressed fluid is the same source of compressed fluid used to drive said turbine during said emergency mode of operation.

34. The system defined in claim 29, wherein said source of compressed fluid is a pressurized tank, a compressor, or a cavern.

35. The system defined in claim 29, wherein said fluid/oil mixture is atomized oil droplets.

36. The system defined in claim 29, wherein said compressed fluid is a compressed gas and said fluid/oil mixture is a gas/oil mixture.

37. The system defined in claim 36, wherein said compressed gas is compressed air and said gas/oil mixture is an air/oil mixture.

38. A lubrication system for use in a continuous compressed air storage power supply that lubricates at least one mechanical component during an active mode of operation, said system comprises:
a source of compressed fluid;
a source of oil;
a fluid/oil mixture assembly coupled to said fluid source, said oil source, and said at least one mechanical component, said assembly operable to mix said compressed fluid and said oil to produce a fluid/oil mixture; and
control circuitry coupled to said assembly and operative to control said assembly to continuously apply said fluid/oil mixture to said at least one mechanical component at a variable rate determined by the lubrication status of said mechanical component.
